(19) United States
(12) Patent Application Publication
(10) Pub. No.: US 2025/0116138 A1
(43) Pub. Date: Apr. 10, 2025

(54) SINGLE MOTOR E-RELEASE LATCH WITH DOUBLE LOCK/CHILD LOCK

(71) Applicant: MAGNA CLOSURES INC., Newmarket (CA)

(72) Inventor: Roman CETNAR, Newmarket (CA)

(21) Appl. No.: 18/887,019

(22) Filed: Sep. 16, 2024

Related U.S. Application Data
(60) Provisional application No. 63/542,346, filed on Oct. 4, 2023.

(51) Int. Cl. E05B 81/90; E05B 81/16; E05B 81/34; E05B 81/42

(52) U.S. Cl. CPC E05B 81/90; E05B 81/16; E05B 81/34; E05B 81/42

(57) ABSTRACT

A power latch assembly and system therewith configured for retaining a closure panel of a motor vehicle in a closed position relative to a vehicle body and for releasing the closure panel to allow the closure panel to be moved from the closed position to an open position. The power latch assembly has a double lock/child lock state, whereat actuation of an inside release mechanism does not release the closure panel for movement to the open position, and whereat actuation of an outside release mechanism permits release of the closure panel for movement to the open position.

### CROSS-REFERENCE TO RELATED APPLICATIONS

This application claims the benefit of U.S. Provisional Application Ser. No. 63/542,346, filed Oct. 4, 2023, which is incorporated herein by reference in their entirety.

### FIELD

The present disclosure relates generally to power door systems for motor vehicles. More particularly, the present disclosure is directed to a power door system equipped with a power latch assembly operable for powered holding, powered releasing, powered double lock and powered child lock.

### BACKGROUND

This section provides background information related to the present disclosure which is not necessarily prior art.

In view of increased consumer demand for motor vehicles equipped with advanced comfort and convenience features, many current vehicles are now provided with power actuated latch assemblies operable via passive keyless entry systems to permit powered locking and powered release of the latch assembles without the use of traditional manual entry mechanisms. Although such power actuated latch assemblies provide desired functionality under normal operating conditions, further advancements are desired to ensure features of the power actuated latch assemblies attain their intended position and functionality repeatedly and reliably in a quick, efficient manner, while minimizing the size, cost, and number of components of the power actuated latch assembly, while further providing a manual override functionality via an outside release mechanism while in a locked state.

In view of the above, there remains a desire to develop alternative power door latch assemblies which address and overcome limitations associated with known power door latch assemblies to provide enhanced powered and manual override functionality, while minimizing size, cost and complexity associated with such advancements.

### SUMMARY

This section provides a general summary of the present disclosure and is not a comprehensive disclosure of its full scope or all of its features, aspects and objectives.

It is an aspect of the present disclosure to provide a power latch assembly for selectively releasing a vehicle closure panel from a locked state via manual actuation of an outside release mechanism for desired movement of the closure panel from a closed position to an open or deployed positions relative to a vehicle body when desired.

In accordance with these and other aspects, a power latch assembly for a motor vehicle having a vehicle body defining a closure opening and a vehicle closure panel pivotably connected to the vehicle body for movement between open and closed positions relative to the closure opening is provided. The power latch assembly of the present disclosure includes a power release actuator arranged to move a power release gear from a home position to an release position to move a pawl from a ratchet holding position to a ratchet releasing position and to cause a ratchet to move from a striker capture position, whereat the ratchet is in latched engagement with a striker to maintain the closure panel in the closed position, to a striker releasing position out of latched engagement from the striker to allow the closure panel to be moved from the closed position to the open position. The power release actuator is arranged to move the power release gear from the home position to a lock position. An outside door release mechanism is arranged to mechanically move the pawl from the ratchet holding position to the ratchet releasing position while the power release gear is in the home position and, the outside door release mechanism is operable to mechanically move the pawl from the ratchet holding position to the ratchet releasing position while the power release gear is in the lock position.

In accordance with another aspect, the outside door release mechanism includes an outside door handle operably coupled to an outside release lever to move the outside release lever between a deactivated position and an activated position, the outside release lever pivotably coupled to a lock link, the lock link being moveable between an unlocked position, whereat the power release gear is in the home position, and a locked position, whereat the power release gear is in the lock position.

In accordance with another aspect, the power release gear has a lock cam arranged to move the lock link from the unlocked position to the locked position upon moving from the home position to the lock position.

In accordance with another aspect, a toggle spring is arranged for engagement with the lock cam to releasably maintain the power release gear in the lock position.

In accordance with another aspect, a first movement of the outside release lever from the deactivated position to the activated position while the power release gear is in the lock position causes the lock cam to overcome a bias imparted by the toggle spring, whereupon the power release gear moves from the lock position to the home position, whereat the lock link is moved to the unlocked position.

In accordance with another aspect, a second movement of the outside release lever from the deactivated position to the activated position causes the pawl (34) to move from the ratchet holding position to the ratchet releasing position.

In accordance with another aspect, an inside door release mechanism is arranged to move the pawl from the ratchet holding position to the ratchet releasing position while the power release gear is in the home position, the inside door release mechanism being inoperable to move the pawl from the ratchet holding position to the ratchet releasing position while the power release gear is in the lock position.

In accordance with another aspect, the inside door release mechanism includes an inside door handle operably coupled to an inside release lever to move the inside release lever between a deactivated position and an activated position, the inside release lever having an arm arranged to drive the lock link while the lock link is in the unlocked position, whereat the lock link drives the outside release lever, which drives a pawl lever and causes the pawl to move from the ratchet holding position to the ratchet releasing position.

In accordance with another aspect, the arm of the inside release lever is inoperable to drive the lock link while the lock link is in the locked position.

In accordance with another aspect, the inside release lever and the outside release lever are arranged for pivotal movement about a first axis, and the lock link being pivotal relative to the outside release lever about a second axis spaced from the first axis.

In accordance with another aspect, the outside door release mechanism is not associated with an outside door handle.

In accordance with another aspect, the outside door release mechanism is associated with a key cylinder.

In accordance with another aspect, a method of mechanically moving a power latch assembly for a motor vehicle from a latched state to an unlatched state to allow a closure panel to be moved from a closed position to an open position is provided. The method includes a step of arranging a power release actuator to move a power release gear from a home position to a release position to move a pawl from a ratchet holding position, whereat a ratchet is in latched engagement with a striker in a striker capture position to maintain the closure panel in a closed position, to a ratchet releasing position, whereat the ratchet moves from the striker capture position to a striker releasing position out of latched engagement from the striker to allow the closure panel to be moved from the closed position to the open position. A further step includes arranging the power release actuator to move the power release gear from the home position to a lock position, and a step of arranging an outside door release mechanism to mechanically move the pawl from the ratchet holding position to the ratchet releasing position while the power release gear is in the home position. Further, a step of arranging the outside door release mechanism to mechanically move the pawl from the ratchet holding position to the ratchet releasing position while the power release gear is in the lock position.

In accordance with another aspect, the method can include a step of operably coupling an outside door handle to an outside release lever to move the outside release lever between a deactivated position and an activated position in response to actuation of the outside door handle, and a step of coupling the outside release lever to a lock link to move the lock link between an unlocked position when the power release gear is in the home position, and a locked position when the power release gear is in the lock position.

In accordance with another aspect, the method can include a step of providing the power release gear having a lock cam arranged to move the lock link from the unlocked position to the locked position upon moving from the home position to the lock position.

In accordance with another aspect, the method can include a step of providing a toggle spring arranged for engagement with the lock cam to releasably maintain the power release gear in the lock position.

In accordance with another aspect, the method can include a step of causing the lock cam to overcome a bias imparted by the toggle spring while the power release gear is in the lock position during a first movement of the outside release lever from the deactivated position to the activated position, and causing the power release gear to move from the lock position to the home position, and causing the lock link to move to the unlocked position.

In accordance with another aspect, the method can include a step of causing the pawl to move from the ratchet holding position to the ratchet releasing position during a second movement of the outside release lever from the deactivated position to the activated position.

In accordance with another aspect, the method can include a step of providing the outside door release mechanism to be associated with a mechanism other than an outside door handle.

In accordance with another aspect, the method can include a step of associating the outside door release mechanism with a key cylinder.

### BRIEF DESCRIPTION OF THE DRAWINGS

These and other aspects, features, and advantages of the present disclosure will be readily appreciated, as the same becomes better understood by reference to the following detailed description when considered in connection with the accompanying drawings wherein:

FIG. 1A illustrates an example motor vehicle equipped with a power door actuation system situated between a front passenger swing door and a vehicle body and which is configured to include a power latch assembly in accordance with one aspect of the disclosure;

FIG. 1B is a partial perspective view showing the power latch assembly installed in the passenger swing door associated with the vehicle shown in FIG. 1A;

FIGS. 2A-2D illustrate front views of a power latch assembly in accordance with the disclosure, with the power latch assembly shown in progressively disassembled states for illustration of various components thereof;

FIGS. 3A-3C illustrate rear views of a power latch assembly in accordance with the disclosure, with the power latch assembly shown in progressively disassembled states for illustration of various components thereof;

FIG. 4 is a perspective view of a power release gear of the power latch assembly of FIGS. 2A through 3C;

FIG. 4A illustrates a fragmentary plan view of the power latch assembly of FIG. 4 with the power release gear shown in a pre-travel release position;

FIG. 4B is a view similar to FIG. 4A with the power release gear shown in a full-travel lock position;

FIG. 5A is a view similar to FIG. 4A with the power release gear shown in a home position;

FIG. 5B is a view similar to FIG. 5A with the power release gear being moved to the pre-travel release position;

FIG. 5C is a view similar to FIG. 5B with the power release gear continuing movement to a full-travel release position, whereat a pawl lever is moved to the full-travel release position, thereby causing a pawl to move to a ratchet releasing position, thereby causing a ratchet to move from a striker capture position to a striker releasing position;

FIG. 6A is a view similar to FIG. 5A;

FIG. 6B illustrates the power release gear being moved to the pre-travel lock position;

FIG. 6C is a view similar to FIG. 6B with the power release gear continuing movement to a double lock/child lock position, whereat the pawl lever is prevented from moving to a release position, thereby preventing the pawl from moving to a ratchet releasing position in response to actuation of an inside release mechanism, thereby preventing the ratchet from moving from the striker capture position to the striker releasing position;

FIG. 7 illustrates a fragmentary plan view of the power latch assembly with the power release gear shown in the home position, with the pawl lever moved to the release position in response to manual actuation of an outside release mechanism;

FIG. 8 illustrates a fragmentary plan view of the power latch assembly with the power release gear shown in the home position, with the pawl lever moved to the release position in response to manual actuation of the inside release mechanism;

FIG. 9 illustrates a fragmentary plan view of the power latch assembly with the power release gear shown in the double lock/child lock position, with the pawl lever prevented from moving to the release position in response to manual actuation of the inside release mechanism;

FIG. 10A illustrates a fragmentary view of the power latch assembly with the power release gear in the double lock/child lock position;

FIG. 10B illustrates a first actuation of the outside release mechanism with the power release gear in the double lock/child lock position, whereupon the power release gear is moved from the double lock/child lock position to the home position; and

FIG. 10C illustrates the lock link moved to the unlocked position in response to the first actuation of the outside release mechanism of FIG. 10B, whereat a second actuation of the outside release mechanism causes the pawl lever to move to the release position.

### DETAILED DESCRIPTION OF EXAMPLE EMBODIMENTS

In general, example embodiments of a power door actuation system including a power latch assembly constructed in accordance with the teachings of the present disclosure will now be disclosed. The example embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail, as they will be readily understood by the skilled artisan in view of the disclosure herein.

The terminology used herein is for the purpose of describing particular example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When an element or layer is referred to as being “on,” “engaged to,” “connected to,” or “coupled to” another element or layer, it may be directly on, engaged, connected or coupled to the other element or layer, or intervening elements or layers may be present. In contrast, when an element is referred to as being “directly on,” “directly engaged to,” “directly connected to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

Spatially relative terms, such as “inner,” “outer,” “beneath,” “below,” “lower,” “above,” “upper,” “top”, “bottom”, and the like, may be used herein for ease of description to describe one element's or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated degrees or at other orientations) and the spatially relative descriptions used herein interpreted accordingly.

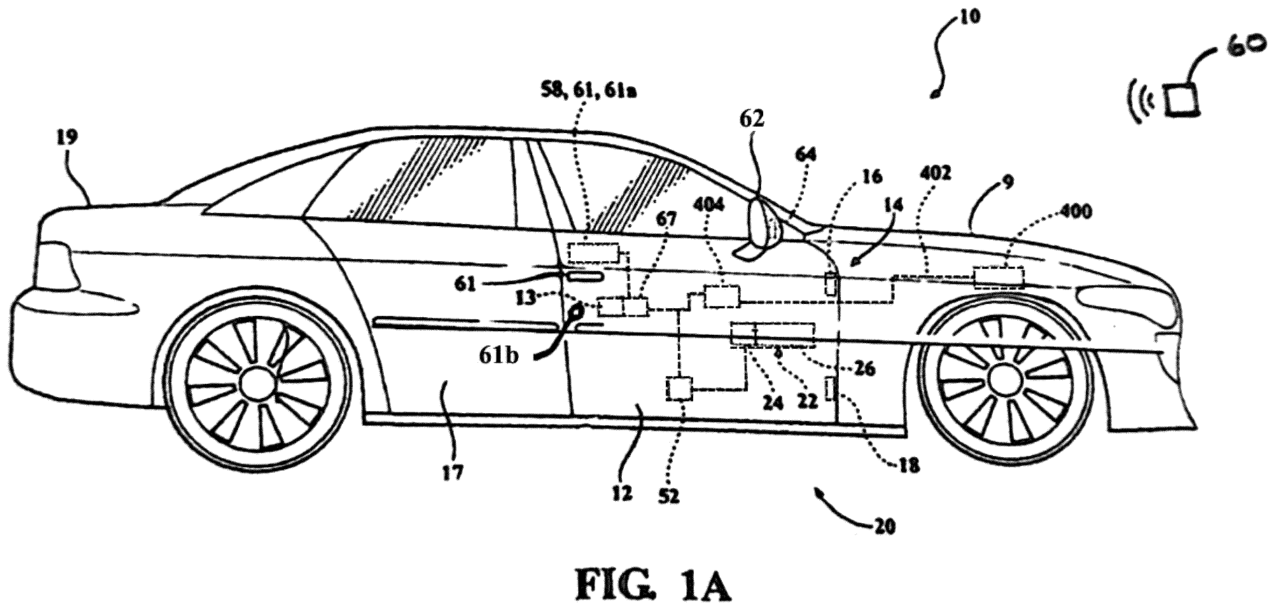

Referring initially to FIG. 1A, an example motor vehicle 10 is shown to include a first closure panel, shown by way of example and without limitation as a front passenger swing door, referred to hereafter simply as passenger door, swing door or door 12, pivotally mounted to a vehicle body 14 via an upper door hinge 16 and a lower door hinge 18 which are shown in dashed lines. In accordance with the present disclosure, a power door actuation system 20 is associated with the swing door 12, and in accordance with a preferred configuration, power door actuation system 20 includes a power latch assembly 13, a vehicle door electric control unit (ECU) 52, and can also be configured with a power-operated swing door actuator 22 secured within an internal cavity of passenger door 12 for coordinated control of the opening and closing of the door 12, if desired. The motor vehicle 10 illustrated in FIG. 1A may be provided including mechanically actuatable outside release mechanism(s), such as outside vehicle door handles 61, and inside release mechanism(s), such as inside door handles 61a, by way of example and without limitation, on the vehicle door 12.

Each of upper door hinge 16 and lower door hinge 18 include a door-mounting hinge component and a body-mounted hinge component that are pivotably interconnected with one another by a hinge pin or post. While power door actuation system 20 is only shown in FIG. 1A in association with front passenger door 12, those skilled in the art will recognize that the power door actuation system 20 and power latch assembly 13 thereof can also be associated with any other door, such as rear passenger doors 17 as shown in FIG. 1B, or also be associated with other closure panels, such as a liftgate (not shown), a hood 9, or a decklid 19. Also, while the door 12 is illustrated herein as being pivotally mounted to the vehicle body 14 for rotation relative to a vertical or generally vertical axis extending through upper and lower hinges 16, 18, it may be configured for rotation about a horizontal axis as would be the case for a liftgate, or other offset (oblique) axis, or the like. For greater clarity, the vehicle body 14 is intended to include the ‘non-moving’ structural elements of the vehicle 10, such as the vehicle frame, structural support pillars and members, and body panels.

Referring to FIG. 1B, shown is a non-limiting embodiment of power latch assembly 13 for vehicle doors 12, 17 of vehicle 10. Power latch assembly 13 can be positioned on vehicle door(s) 12, 17 and arranged in a suitable orientation to engage and retain a striker 37, mounted on vehicle body 14, when door 12, 17 is closed.

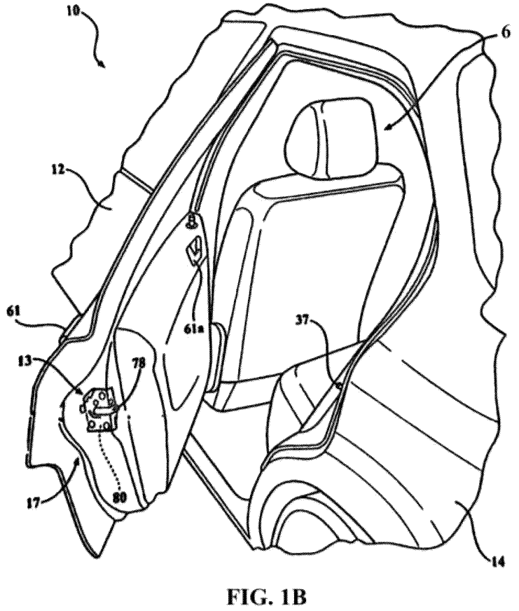

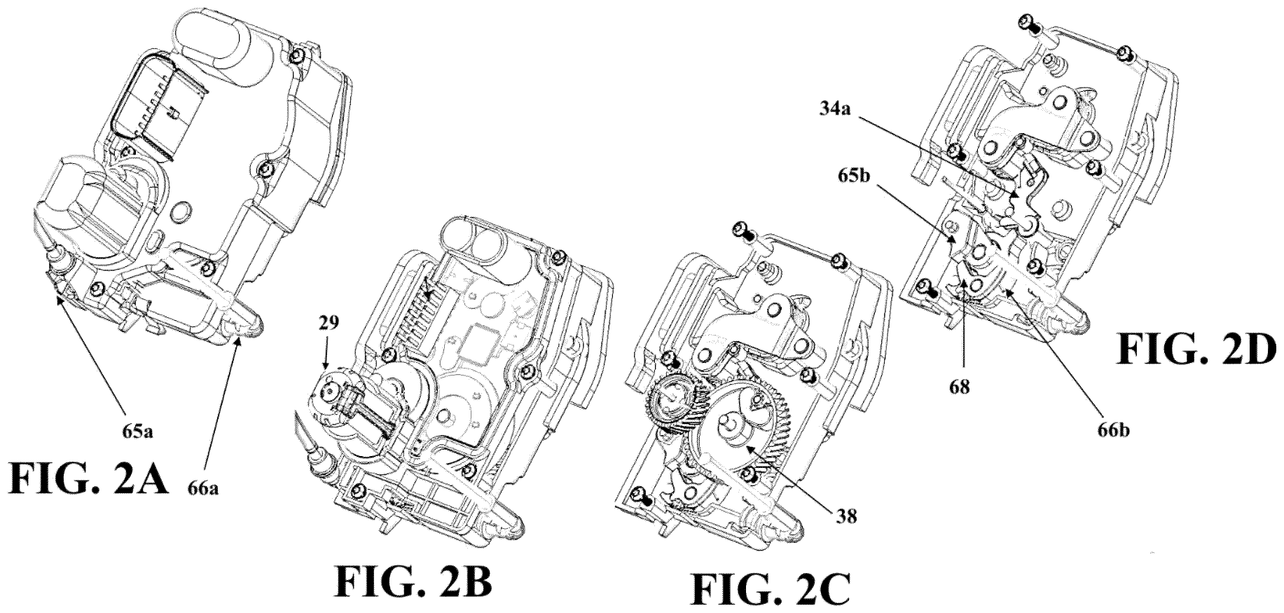

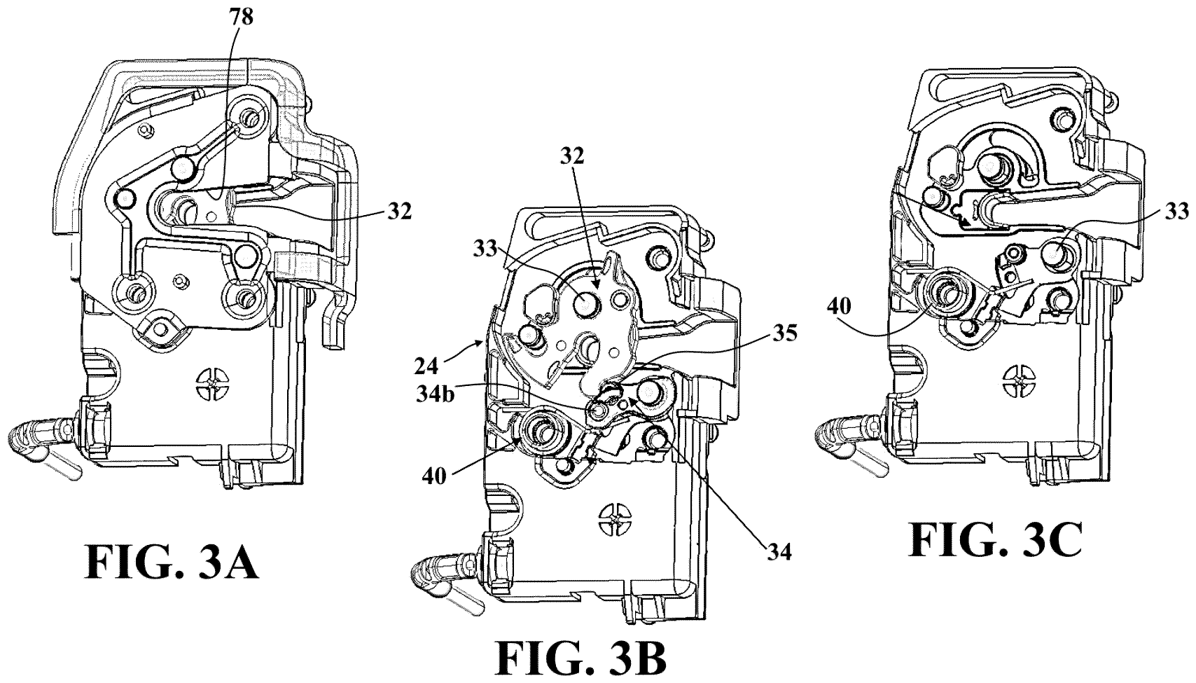

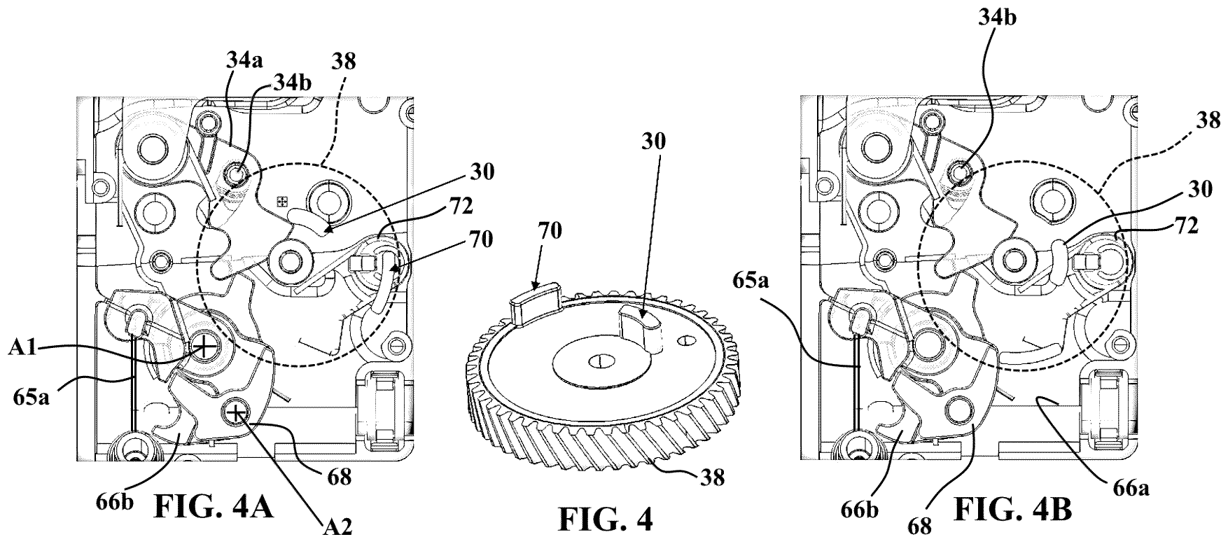

Power latch assembly 13 is configured for a power release operation. Power latch assembly 13 includes a power release actuator, also referred to as power actuator 29 (FIG. 2B), such as an electric motor, for controlling powered actuation of a latch release mechanism 24. Power latch assembly 13 includes a ratchet 32 that is moveable between two striker capture positions about a ratchet axis, referred to hereafter as axis, defined by a ratchet rivet, also referred to as ratchet pin 33. Ratchet 32 pivots about axis between a primary or fully closed position (shown in FIGS. 3A and 3B), also referred to as primary striker capture position or primary locking position, and a secondary or partially closed position (not shown), also referred to as secondary striker capture position or secondary locking position, whereat ratchet 32 retains striker 37 against being fully released while in both positions. Ratchet 32 is also moveable to a striker release position (not shown), whereat ratchet 32 permits release of striker 37 from a fishmouth 78 (FIGS. 1B and 3A) provided by a latch housing, also referred to as frame plate 80, of power latch assembly 13. A ratchet biasing member (not shown) such as a spring, is provided to normally bias ratchet 32 toward its striker release position, corresponding to a counterclockwise direction, as viewed in FIGS. 3A and 3B. A pawl 34 (FIG. 3B) is movable about a pawl axis defined by a pawl rivet, also referred to as pawl pin 35 (FIGS. 3B and 3C). Pawl 34 pivots about pawl axis between at least one ratchet holding position (FIG. 3B), whereat pawl 34 holds ratchet 32 in its closed, striker capture position(s), wherein swing door 12 is maintained in a closed state, also referred to as closed position, thereby being restrained against being fully opened, and a ratchet releasing position, whereat pawl 34 permits ratchet 32 to move to its open, striker release position, wherein swing door 12 can be moved to a fully open state, also referred to as open position. A pawl biasing member 40, such as a suitable spring, is provided to normally bias pawl 34 toward its ratchet holding position.

Power release actuator 29 can be used as part of a conventional passive keyless entry feature. When a person approaches vehicle 10 with an electronic key fob 60 (shown schematically in FIG. 1A) and actuates the outside door handle 61, for example, sensing both the presence of key fob 60 and that outside door handle 61 has been actuated (e.g. via communication between a switch (not shown) and a latch electronic control unit (ECU) shown at 67 (FIG. 1A) that at least partially controls the operation of power latch assembly 13. In turn, latch ECU 67 signals and actuates power release actuator 29 to cause the latch release mechanism 24 to cause pawl 34 to be pivoted to its ratchet releasing position to release ratchet 32 to move under the bias of ratchet biasing member to its striker release position and shift power latch assembly 13 into an unlatched operating state so as to facilitate subsequent opening of swing door 12. Power release actuator 29 can be alternatively activated as part of a proximity sensor based entry feature (radar based proximity detection for example), for example when a person approaches vehicle 10 with an electronic key fob 60 and actuates a proximity sensor 58, such as a capacitive sensor, or other touch/touchless based sensor (based on a recognition of the proximity of an object, such as the touch/swipe/hover/gesture or a hand or finger, or the like), (e.g. via communication between the proximity sensor 58 (FIG. 1A) and latch ECU 67 (FIG. 1A) that at least partially controls the operation of closure latch assembly 13). In turn, latch ECU 67 signals power release actuator 29 to move and cause the latch release mechanism 24 to shift power latch assembly 13 into an unlatched operating state to facilitate subsequent opening of vehicle door 12. Also, power release actuator 29 can be used in coordinated operation with power-operated swing door actuator 22. Further yet, outside door handle 61 may be configured for mechanical actuation of power latch assembly 13 to facilitate opening the swing door 12, as will be understood by a person possessing ordinary skill in the art of latches, such as, by way of example and without limitation, during power interruption and/or upon experiencing a crash condition, as discussed further below.

The door 12 may have a conventional opening lever or inside door handle 61a located on an interior facing side of the door 12 facing the inside of the passenger compartment C for opening the door 12 (e.g. including unlocking and opening the power latch assembly 13, as well as commanding operation of the power-operated swing door actuator 22). This opening lever or inside door handle 61a can trigger a switch 63a connected operably to the latch ECU 67 such that, when the switch 63a is actuated, the latch ECU 67 signals and facilitates power latch assembly 13 being activated. Subsequently, the latch ECU 67 may facilitate that the power-operated swing door actuator 22 is activated (i.e. the extension member 26 is deployed or extended) to continue the automatic opening of the swing door 12. In the alternative, the power-operated swing door actuator 22 may be powered on at a point before the final presentment position is reached so as to provide a seamless transition between the two stages of door opening (i.e. both motors are overlapping in operation for a short time period). Alternatively, the latch ECU 67 may facilitate that the power-operated swing door actuator 22 is operated as a door check (i.e. the extension member 26 is deployed or extended and maintained at such a deployed or extended condition) until the user manually takes control of the swing door 12 to further open it to a fully opened position. Further yet, inside door handle 61a may be configured for mechanical actuation of power latch assembly 13, via intervening mechanical mechanism(s), to facilitate opening the swing door 12, as will be understood by a person possessing ordinary skill in the art of latches, such as during power interruption and/or upon experiencing a crash condition, as discussed further below.

Now referring back to FIG. 1A, the power door actuation system 20 and the power latch assembly 13 are electrically connected to a main power source 400 of the motor vehicle 10, for example a main battery providing a battery voltage V_{batt} of 12 V, through an electrical connection element 402, for example a power cable (the main power source 400 may equally include a different source of electrical energy within the motor vehicle 10, for example an alternator). The electronic latch ECU 67 and/or swing door ECU 52 are also coupled to the main power source 400 of the motor vehicle 10, so as to receive the battery voltage V_{batt}; the electronic latch ECU 67 and/or swing door ECU 52 are thus able to check if the value of the battery voltage V_{batt} decreases below a predetermined threshold value, to promptly determine if an emergency condition (when a backup energy source may be needed) occurs.

As shown in the schematic block diagram of FIG. 1A, a backup energy source 404, which may be integrated forming part of an electronic control circuit of the electronic latch ECU 67 and/or swing door ECU 52, or may be separate therefrom, is configured to supply electrical energy to the power door actuation system 20 and/or the power latch assembly 13, and to the same electronic control circuit of the electronic latch ECU 67 and/or swing door ECU 52, in case of failure or interruption of the main power supply from the main power source 400 of the motor vehicle 10.

In an illustrative example, the backup energy source 404 includes a group of low voltage supercapacitors (not shown) as an energy supply unit (or energy tank) to provide power backup to the power door actuation system 20 and/or the power latch assembly 13, even in case of power failures. Supercapacitors may include electrolytic double layer capacitors, pseudocapacitors or a combination thereof. Other electronic components and interconnections of the backup energy source 404, such as a boost module to increase the voltage from the backup energy source 404 to an actuator, such as the power-operated swing door actuator for example, are disclosed in co-owned patent application US2015/0330116, which is incorporated herein by way of reference in its entirety.

Swing door ECU 52 can also receive an additional input from a proximity sensor 64 (e.g. ultrasonic or radar) positioned on a portion of swing door 12, such as on a door mirror M, or the like, as shown in FIG. 1A. Proximity sensor 64 assesses if an obstacle, such as another car, tree, post, or otherwise, is near or in close proximity to vehicle door 12. If such an obstacle is present, proximity sensor 64 will send a signal to swing door ECU 52, and swing door ECU 52 will proceed to turn off electric motor 24 to stop movement of swing door 12, and thus prevent vehicle door 12 from hitting the obstacle.

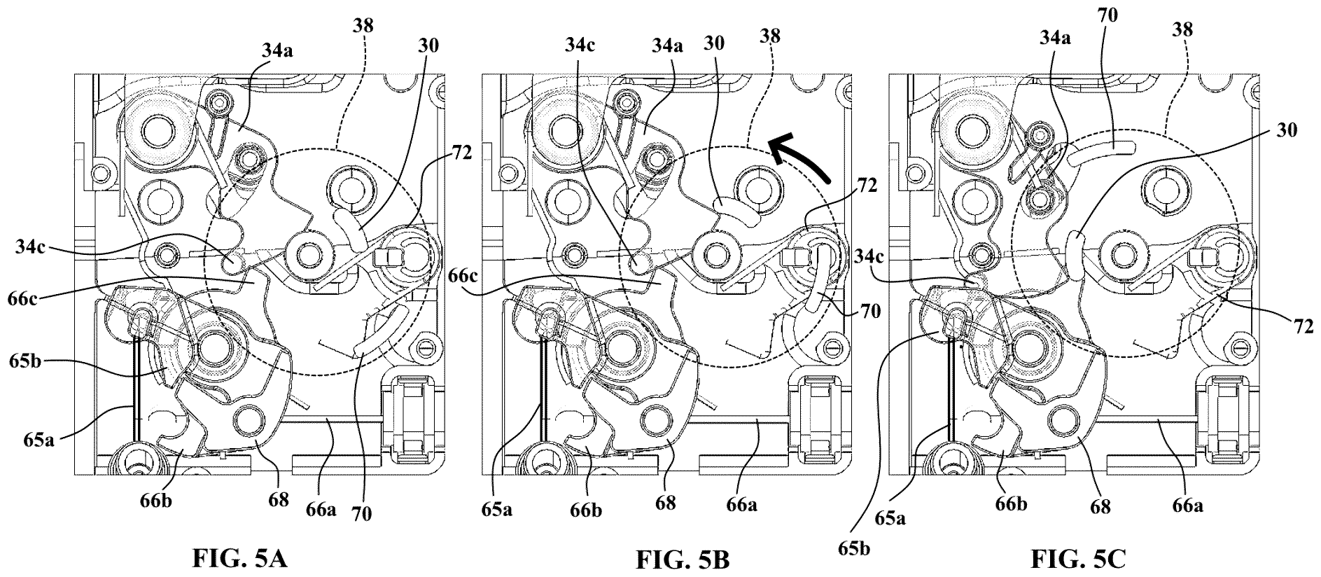

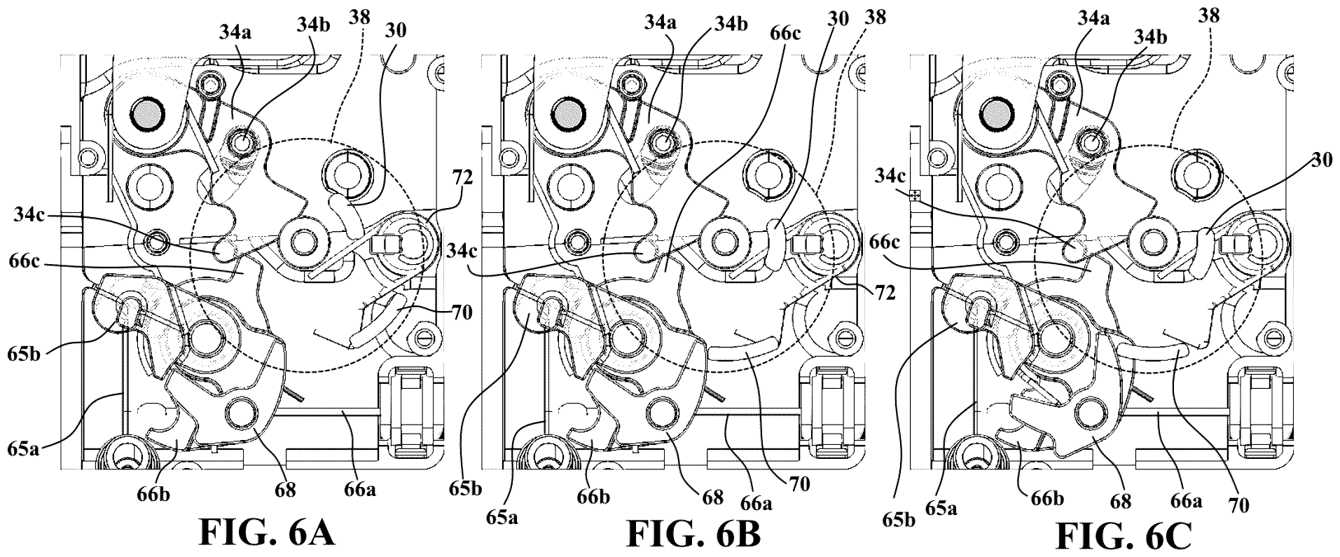

The power release actuator 29 is arranged to move a power release gear 38 from a home position (FIG. 5A) to a release position (FIG. 5C). As power release gear 38 is driven toward the release position, a first cam, also referred to as release cam 30 engages and drives a pawl lever 34a, whereupon pawl lever 34a, via operable coupling with pawl 34, such as via a pawl drive pin 34b, drives pawl 34 from a ratchet holding position to a ratchet releasing position, thereby causing ratchet 32 to move from a striker capture position, whereat the ratchet 32 is in latched engagement with striker 37 to maintain closure panel 12 in a closed position, to a striker releasing position out of latched engagement from the striker 37, thereby allowing the closure panel 12 to be moved from the closed position to the open position. The power release actuator 29 is further arranged to move the power release gear 38 from the home position (FIG. 6A) to a lock position (FIG. 6C). As shown in FIG. 8, an inside door release mechanism, such as inside door handle 61a, is arranged to move the pawl 34, via an inside release cable 65a coupled to an inside release lever 65b, from the ratchet holding position to the ratchet releasing position while the power release gear 38 is in the home position. Inside release lever 65 is arranged for pivotal movement about a first axis A1 in response to actuation of inside release cable 65a. During pivotal movement of inside release lever 65b about first axis A1, an arm 65c of inside release lever 65b drives a double lock/child lock link, also referred to as lock link 68, about a second axis A2 spaced from first axis A1, which in turns drives an outside release lever 66b for pivotal movement about first axis A1, whereupon an arm 66c of outside release lever 66b drives a protrusion 34c of pawl lever 34a, thereby causing pawl lever 34a to drive pawl 34 from the ratchet holding position to the ratchet releasing position. As shown in FIG. 9, the inside door release mechanism 61a is inoperable to move the pawl 34 from the ratchet holding position to the ratchet releasing position while the power release gear 38 is in the lock position. During movement of power release gear 38 to the lock position, arm 65c of inside release lever 65b is moved out from driving engagement with lock link 68, thereby being unable to drive lock link 68, and thus, being unable to cause driven movement of outside release lever 66b, which in turn prevents arm 66c from driving protrusion 34c or pawl lever 34a.

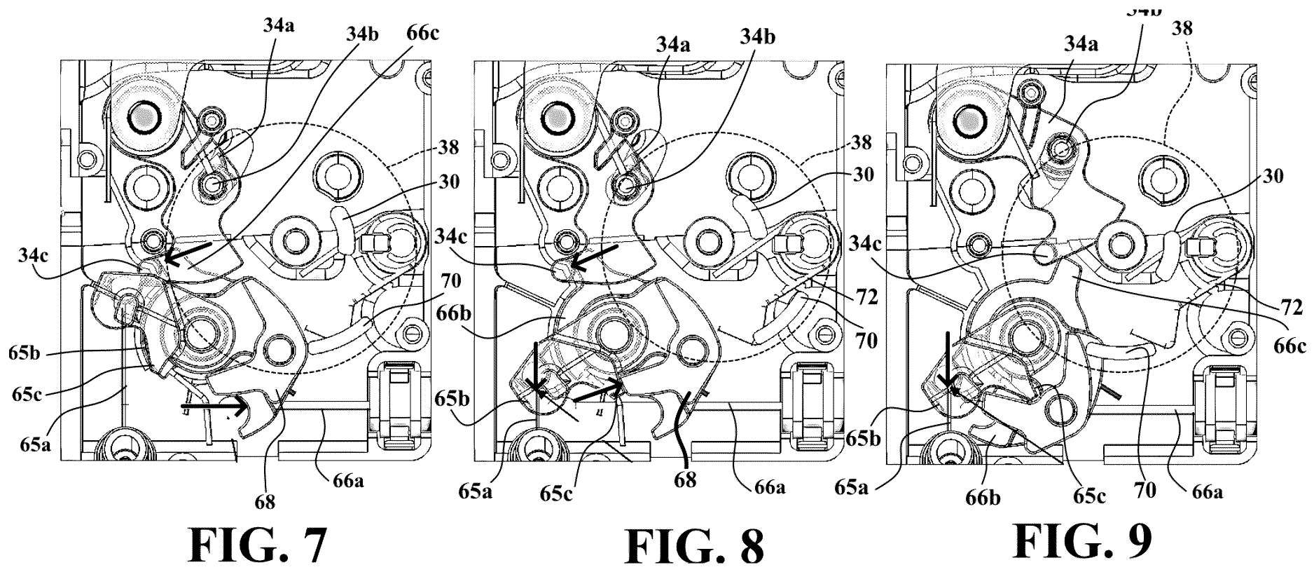

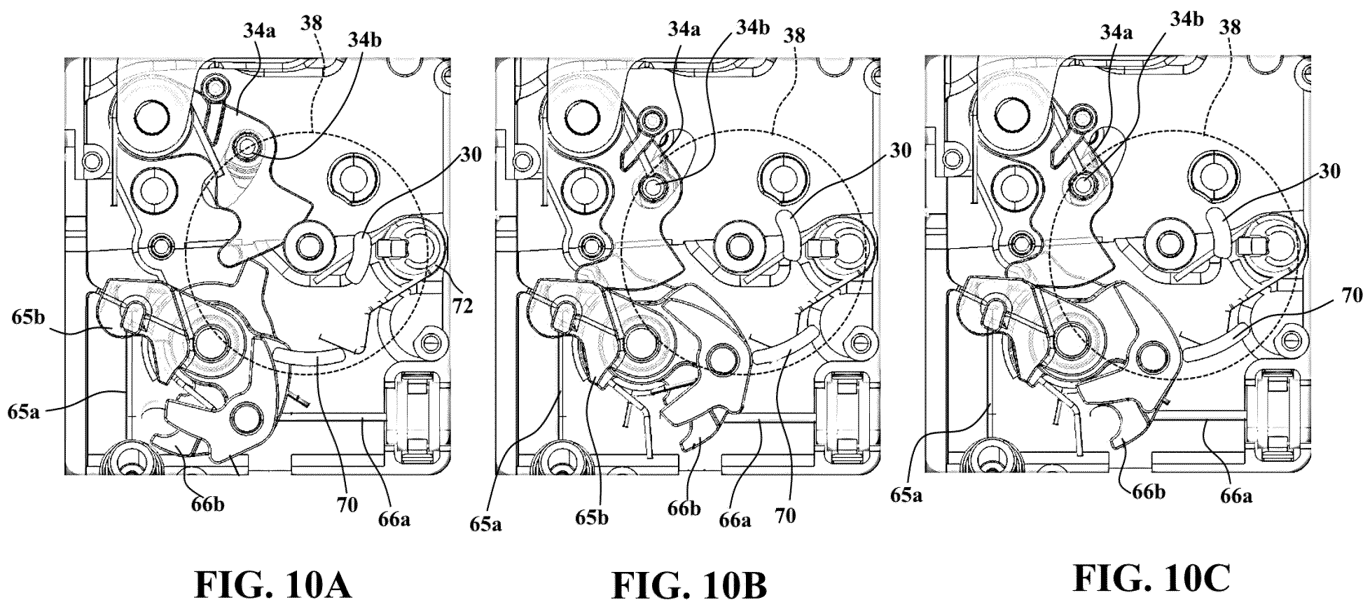

As shown in FIG. 7, an outside door release mechanism 61 is arranged to mechanically move the pawl 34 from the ratchet holding position to the ratchet releasing position while the power release gear 38 is in the home position via direct movement of outside release lever 66b by an outside release cable 66a, wherein arm 66c of outside release lever 66b drives protrusion 34c, as discussed above for inside release lever 65b. As shown sequentially in FIGS. 10A-10C, the outside door release mechanism 61 is also operable to mechanically move the pawl 34 from the ratchet holding position to the ratchet releasing position while the power release gear 38 is in the lock position.

The outside door release mechanism includes outside door handle 61 operably coupled to outside release lever 66b via an outside release cable 66a to move the outside release lever 66b between a deactivated position and an activated position. The outside release lever 66b is pivotably coupled to lock link 68 for relative pivotal movement of lock link 68 about second axis A2. The lock link 68 is moveable between an unlocked position (FIG. 5A-5C, 6A), whereat the power release gear 38 is in the home position, and a locked position (FIG. 6C), whereat the power release gear 38 is in the lock position.

The power release gear 38 has a second cam, also referred to as lock cam 70, arranged to engage and move the lock link 68 from the unlocked position to the locked position upon power release gear 38 moving from the home position to the lock position. Lock cam 70 extends from the same side of power release gear 38 as release cam 30 in circumferentially spaced relation therefrom. Lock cam 70 is further shown located in radially outward relation from release cam 30 relative to the rotational axis of power release gear 38. A toggle spring 72 is arranged for biased engagement with the lock cam 70 to releasably maintain the power release gear 38 in the lock position (FIGS. 6C and 9). A first movement of the outside release lever 66b from the deactivated position to the activated position, via selective actuation of an outside actuation member, such as outside door handle 61 (it is contemplated that the movement of outside release lever 66b could be caused by other than actuation of outside door handle 61, such as by an outside key cylinder 61b or otherwise), while the power release gear 38 is in the lock position causes the lock cam 70 to overcome a bias imparted by the toggle spring 72, whereupon the power release gear 38 moves from the lock position to the home position, whereat the lock link 68 is moved to the unlocked position, as shown in FIGS. 10A-10C. A second movement of the outside release lever 66b from the deactivated position to the activated position, via selective actuation of outside door handle 61, causes pawl lever 34a to drive the pawl 34 to move from the ratchet holding position to the ratchet releasing position, thereby allowing ratchet 32 to move under the bias of ratchet biasing member to the striker releasing position, as discussed above for FIG. 7. Accordingly, although door 12 is in a double lock/child lock state, it is possible to open door 12 via mechanical actuation of the outside actuation member 61 to move lock link 68 to the unlocked position, regardless of whether power is supplied to the power latch assembly 13 or not. Accordingly, activation of outside actuation member 61, as discussed above, serves to by-pass a locked state to allow door 12 to be intentionally opened.

In accordance with another aspect of the disclosure, a method of mechanically moving a power latch assembly (13) for a motor vehicle (10) from a latched state to an unlatched state to allow a closure panel to be moved from a closed position to an open position is provided. The method includes a step of arranging a power release actuator 29 to move a power release gear 38 from a home position to a release position to move a pawl 34 from a ratchet holding position, whereat a ratchet 32 is in latched engagement with a striker 37 in a striker capture position to maintain the closure panel 12 in a closed position, to a ratchet releasing position, whereat the ratchet 32 moves from the striker capture position to a striker releasing position out of latched engagement from the striker 37 to allow the closure panel 12 to be moved from the closed position to the open position. Further, a step of arranging the power release actuator 29 to move the power release gear 38 from the home position to a lock position. Further, a step of arranging an outside door release mechanism 61 to mechanically move the pawl 34 from the ratchet holding position to the ratchet releasing position while the power release gear 38 is in the home position. Further yet, a step of arranging the outside door release mechanism 61 to mechanically move the pawl 34 from the ratchet holding position to the ratchet releasing position while the power release gear 38 is in the lock position.

In accordance with another aspect, the method can include a step of operably coupling an outside door handle 61 to an outside release lever 66b to move the outside release lever 66b between a deactivated position and an activated position in response to actuation of the outside door handle, and coupling the outside release lever 66b to a lock link 68 to move the lock link 68 between an unlocked position when the power release gear 38 is in the home position, and a locked position when the power release gear 38 is in the lock position.

In accordance with another aspect, the method can include a step of providing the power release gear 38 having a lock cam 70 arranged to move the lock link 68 from the unlocked position to the locked position upon moving from the home position to the lock position.

In accordance with another aspect, the method can include a step of providing a toggle spring 72 arranged for engagement with the lock cam 70 to releasably maintain the power release gear 38 in the lock position.

In accordance with another aspect, the method can include a step of causing the lock cam 70 to overcome a bias imparted by the toggle spring 72 while the power release gear 38 is in the lock position during a first movement of the outside release lever 66b from the deactivated position to the activated position, and causing the power release gear 38 to move from the lock position to the home position, and causing the lock link 68 to move to the unlocked position.

In accordance with another aspect, the method can include a step of causing the pawl 34 to move from the ratchet holding position to the ratchet releasing position during a second movement of the outside release lever 66b from the deactivated position to the activated position.

In accordance with another aspect, the method can include a step of providing the outside door release mechanism 61 to be associated with a mechanism other than an outside door handle.

In accordance with another aspect, the method can include a step of associating the outside door release mechanism 61 with a key cylinder 61b.

The foregoing description of the embodiments has been provided for purpose of illustration and description. It is not intended to be exhaustive or to limit the disclosure. Individual elements, assemblies/subassemblies, or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. A power latch assembly for a motor vehicle, comprising:
a power release actuator arranged to move a power release gear from a home position to a release position to move a pawl from a ratchet holding position to a ratchet releasing position and to cause a ratchet to move from a striker capture position, whereat the ratchet is in latched engagement with a striker to maintain a closure panel in a closed position, to a striker releasing position out of latched engagement from the striker to allow the closure panel to be moved from the closed position to the open position, the power release actuator further arranged to move the power release gear from the home position to a lock position; and
an outside door release mechanism arranged to mechanically move the pawl from the ratchet holding position to the ratchet releasing position while the power release gear is in the home position, the outside door release mechanism being operable to mechanically move the pawl from the ratchet holding position to the ratchet releasing position while the power release gear is in the lock position.

2. The power latch assembly of claim 1, wherein the outside door release mechanism includes an outside door handle operably coupled to an outside release lever to move the outside release lever between a deactivated position and an activated position, the outside release lever pivotably coupled to a lock link, the lock link being moveable between an unlocked position, whereat the power release gear is in the home position, and a locked position, whereat the power release gear is in the lock position.

3. The power latch assembly of claim 2, wherein the power release gear has a lock cam arranged to move the lock link from the unlocked position to the locked position upon moving from the home position to the lock position.

4. The power latch assembly of claim 3, further including a toggle spring arranged for engagement with the lock cam to releasably maintain the power release gear in the lock position.

5. The power latch assembly of claim 4, wherein a first movement of the outside release lever from the deactivated position to the activated position while the power release gear is in the lock position causes the lock cam to overcome a bias imparted by the toggle spring, whereupon the power release gear moves from the lock position to the home position, whereat the lock link is moved to the unlocked position.

6. The power latch assembly of claim 5, wherein a second movement of the outside release lever from the deactivated position to the activated position causes the pawl to move from the ratchet holding position to the ratchet releasing position.

7. The power latch assembly of claim 2, further including an inside door release mechanism arranged to move the pawl from the ratchet holding position to the ratchet releasing position while the power release gear is in the home position, the inside door release mechanism being inoperable to move the pawl from the ratchet holding position to the ratchet releasing position while the power release gear is in the lock position.

8. The power latch assembly of claim 7, wherein the inside door release mechanism includes an inside door handle operably coupled to an inside release lever to move the inside release lever between a deactivated position and an activated position, the inside release lever having an arm arranged to drive the lock link while the lock link is in the unlocked position, whereat the lock link drives the outside release lever, which drives a pawl lever and causes the pawl to move from the ratchet holding position to the ratchet releasing position.

9. The power latch assembly of claim 8, wherein the arm of the inside release lever is inoperable to drive the lock link while the lock link is in the locked position.

10. The power latch assembly of claim 8, wherein the inside release lever and the outside release lever are arranged for pivotal movement about a first axis, and the lock link being pivotal relative to the outside release lever about a second axis spaced from the first axis.

11. The power latch assembly of claim 1, wherein the outside door release mechanism is not associated with an outside door handle.

12. The power latch assembly of claim 11, wherein the outside door release mechanism is associated with a key cylinder.

13. A method of mechanically moving a power latch assembly for a motor vehicle from a latched state to an unlatched state to allow a closure panel to be moved from a closed position to an open position, comprising:
arranging a power release actuator to move a power release gear from a home position to a release position to move a pawl from a ratchet holding position, whereat a ratchet is in latched engagement with a striker in a striker capture position to maintain the closure panel in a closed position, to a ratchet releasing position, whereat the ratchet moves from the striker capture position to a striker releasing position out of latched engagement from the striker to allow the closure panel to be moved from the closed position to the open position;
arranging the power release actuator to move the power release gear from the home position to a lock position;
arranging an outside door release mechanism to mechanically move the pawl from the ratchet holding position to the ratchet releasing position while the power release gear is in the home position; and
arranging the outside door release mechanism to mechanically move the pawl from the ratchet holding position to the ratchet releasing position while the power release gear is in the lock position.

14. The method of claim 13, further including operably coupling an outside door handle to an outside release lever to move the outside release lever between a deactivated position and an activated position in response to actuation of the outside door handle, and coupling the outside release lever to a lock link to move the lock link between an unlocked position when the power release gear is in the home position, and a locked position when the power release gear is in the lock position.

15. The method of claim 14, further including providing the power release gear having a lock cam arranged to move the lock link from the unlocked position to the locked position upon moving from the home position to the lock position.

16. The method of claim 15, further including providing a toggle spring arranged for engagement with the lock cam to releasably maintain the power release gear in the lock position.

17. The method of claim 16, further including causing the lock cam to overcome a bias imparted by the toggle spring while the power release gear is in the lock position during a first movement of the outside release lever from the deactivated position to the activated position, and causing the power release gear to move from the lock position to the home position, and causing the lock link to move to the unlocked position.

18. The method of claim 17, further including causing the pawl to move from the ratchet holding position to the ratchet releasing position during a second movement of the outside release lever from the deactivated position to the activated position.

19. The method of claim 13, further including providing the outside door release mechanism to be associated with a mechanism other than an outside door handle.

20. The method of claim 19, further including associating the outside door release mechanism with a key cylinder.
